(19) United States
(12) Patent Application Publication
(10) Pub. No.: US 2023/0017827 A1
(43) Pub. Date: Jan. 19, 2023

(54) VERTICAL RETRACTABLE COVERING FOR STRUCTURAL OPENINGS

(71) Applicant: Edwin Torres, Cape Coral, FL (US)

(72) Inventor: Edwin Torres, Cape Coral, FL (US)

(21) Appl. No.: 17/949,312

(22) Filed: Sep. 21, 2022

Related U.S. Application Data
(63) Continuation-in-part of application No. 16/854,958, filed on Apr. 22, 2020.
(60) Provisional application No. 62/921,657, filed on Jul. 1, 2019.

(51) Int. Cl. E06B 9/264; E06B 9/262; E06B 9/40

(52) U.S. Cl. CPC E06B 9/264; E06B 9/262; E06B 9/40; E06B 2009/2452

(57) ABSTRACT

The invention relates to a retractable covering for architectural openings that can accommodate different pleated fabric covering sizes without requiring the use of different side rail frame components and is capable of opening either from left to right, right to left or a two-piece construction allowing for the left side to open left and right side to open left.

### CROSS-REFERENCE TO RELATED APPLICATIONS

This application is a Continuation-In-Part Utility Patent application claiming priority to U.S. patent application Ser. No. 16/854,958, filed on Apr. 22, 2020, which in turn claims the benefit of U.S. Provisional patent Application Ser. No. 62/921,657, filed on Jul. 1, 2019, both of which are incorporated by reference herein in their entirety.

### COPYRIGHT STATEMENT

A portion of the disclosure of this patent document contains material that is subject to copyright protection. The copyright owner has no objection to the facsimile reproduction by anyone of the patent document or the patent disclosure as it appears in the Patent and Trademark Office patent file or records, but otherwise reserves all copyright rights whatsoever.

Trademarks used in the disclosure of the invention, and the applicants, make no claim to any trademarks referenced.

### BACKGROUND OF THE INVENTION

### 1) Field of the Invention

The invention relates to the field of covering structural openings, and, more particularly to covering structural openings such as doorways, windows, archways, or the like.

### 2) Description of Related Art

Currently the state of the art includes retractable pleated fabric covering coverings for architectural openings, such as windows, doorways, archways, and the like, have taken numerous forms for many years. Some coverings are in the form of horizontally collapsible panels suspended from a headrail and having one edge connected to a fixed vertical rail and the opposite edge to a movable vertical rail. A trolley is secured to the top of the movable vertical rail and has a horizontal arm supported by and movable along the length of the headrail. The horizontal arm is typically six or so inches in length and includes two pair of horizontally disposed rollers which are disposed at opposite ends of the horizontal arm for rolling movement along the headrail. A problem with prior art retractable pleated fabric covering panels resides in the fact that the panel itself is suspended from the headrail by a plurality of carriers which are also movable along the length of the headrail and supported on a common track with the trolley. Accordingly, the carriers interfere with the trolley at the connection of the retractable panel to the trolley, and as a result, an aesthetic interruption in the panel occurs.

A significant problem with the prior art is the number of different parts required to assemble a retractable covering for architectural openings and the need to have different size side rail frame materials to accommodate the various sizes of fabric used to form the retractable coverings for architectural openings.

Therefore, what is needed in the art is a new and improved system for connecting a retractable vertical panel to a trolley and a headrail along which the trolley can translate without detracting from the aesthetics of the panel and a frame system which can accommodate different fabric sizes.

### BRIEF SUMMARY OF THE INVENTION

The instant invention in one form is directed to The invention in one form is directed to a retractable covering for architectural openings that can accommodate different pleated fabric covering sizes without requiring the use of different side rail frame components and is capable of opening either from left to right, right to left or a two piece construction allowing for the left side to open left and right side to open right.

The invention in another form provides for a reversable trolley that is capable of supporting the moveable vertical rail and the fix vertical rail and an integral hinge which allows it to swivel.

In another aspect, the invention provides for a valance which can be made onsite and is capable of accommodating any length or curvature. The ability to provide a vertical blind that can accommodate any window opening with out unsightly seams increases the architectural desirability of the vertical blind.

In another aspect, the invention provides for a second upper blind which can be deployed to limit glare in a room and allow the user to open the vertical blind and deploy a blind to minimize the architectural view and limit glare.

These and other objects, features, and advantages of the present invention will become more readily apparent from the attached drawings and the detailed description of the preferred embodiments, which follow.

### BRIEF DESCRIPTION OF THE DRAWINGS

A further understanding of the nature and advantages of particular embodiments may be realized by reference to the remaining portions of the specification and the drawings, in which like reference numerals are used to refer to similar components. When reference is made to a reference numeral without specification to an existing sub-label, it is intended to refer to all such multiple similar components.

FIG. 1 there is shown vertical retractable covering for structural openings having a at least two vertical rails;

FIG. 2 shows an end view of the dual headrail configured such that the pleated fabric covering faces the inside of the structural opening;

FIG. 3 is an end view of the dual headrail configured such that the pleated fabric covering faces the outside of the structural opening;

FIG. 4 shows a cross section view of a dual headrail showing a vertical blind in the front or inside of the structural opening and a second fabric covering facing the outside of the structural openings;

FIG. 5 is an isometric view of a side-draw embodiment of the instant invention with continuous valence;

FIG. 6 shows a first dual headrail and a second dual headrail joined together with splicing block to form a single dual headrail;

FIG. 7 shows the continuous valence process;

FIG. 8 shows an enlarged section plan view taken with respect to the larger pleat fabric covering and both vertical rails without the dual headrail or the second fabric covering;

FIG. 9 which shows an enlarged section plan view taken with respect to the smaller pleat fabric covering and both vertical rails without the dual headrail or the second fabric covering;

FIG. 10 shows a vertical rail which is similar to vertical rail showing by channel which the trolley attaches to;

FIG. 11 shows a trolley with vertical rail connecting plate;

FIG. 12 shows an end view of the dual headrail configured such that the pleated fabric covering faces the inside of the structural opening;

FIG. 13 shows a dual headrail with pleated fabric covering a portion of the structural opening and roll shade covering a portion of structural opening leaving uncovered portion of structural opening.

FIG. 14 is a view of a kit of the instant invention:

FIG. 15 is a process flowchart whereby a user can install a fabric covering system of the instant invention using a kit of the instant invention: and

FIG. 16 shows the dual rail assembled from 3 different tracks to form the dual headrail.

FIG. 17 shows end views of alternative configurations of dual headrail.

Corresponding reference characters indicate corresponding parts throughout the several views. The exemplifications set out herein illustrate embodiments of the invention and such exemplifications are not to be construed as limiting the scope of the invention in any manner.

### DETAILED DESCRIPTION

While various aspects and features of certain embodiments have been summarized above, the following detailed description illustrates a few exemplary embodiments in further detail to enable one skilled in the art to practice such embodiments. The described examples are provided for illustrative purposes and are not intended to limit the scope of the invention.

In the following description, for the purposes of explanation, numerous specific details are set forth in order to provide a thorough understanding of the described embodiments. It will be apparent to one skilled in the art however that other embodiments of the present invention may be practiced without some of these specific details. Several embodiments are described herein, and while various features are ascribed to different embodiments, it should be appreciated that the features described with respect to one embodiment may be incorporated with other embodiments as well. By the same token however, no single feature or features of any described embodiment should be considered essential to every embodiment of the invention, as other embodiments of the invention may omit such features.

In this application the use of the singular includes the plural unless specifically stated otherwise and use of the terms “and” and “or” is equivalent to “and/or,” also referred to as “non-exclusive or” unless otherwise indicated. Moreover, the use of the term “including,” as well as other forms, such as “includes” and “included,” should be considered non-exclusive. Also, terms such as “element” or “component” encompass both elements and components including one unit and elements and components that include more than one unit, unless specifically stated otherwise.

Lastly, the terms “or” and “and/or” as used herein are to be interpreted as inclusive or meaning any one or any combination. Therefore, “A, B or C” or “A, B and/or C” mean “any of the following: A; B; C; A and B; A and C; B and C; A, B and C.” An exception to this definition will occur only when a combination of elements, functions, steps or acts are in some way inherently mutually exclusive.

As this invention is susceptible to embodiments of many different forms, it is intended that the present disclosure be considered as an example of the principles of the invention and not intended to limit the invention to the specific embodiments shown and described.

As used in the specification the terms person, individual, technician and user are used interchangeably and mean a person using or assembling the instant invention.

As used in the specification the terms trolley and trolley are used interchangeably and are meant to refer to a carrier of supporting a moveable side rail from the headrail.

As used in the specification the terms covering, panel, pleated fabric covering are used interchangeably to mean the fabric panel used to cover the structural opening.

As used in the specification the term track, channel and cavity are used interchangeably to mean the channel to support the fabric coverings.

As used in the specification the term fabric can mean any material which is flexible and can be formed into a drape, roll shade or pleated configuration. This includes textiles, polymer blends, polymer films, jointed metal, woven materials and fabrics such as linen and polymers.

The prior art does not provide for a system that provides a system that allows multiple size fabrics to be used with a single vertical rail, a continuous made on site valence or a reversable trolly these include U.S. Pat. No. 4,915,153 issued on Apr. 10, 1990, U.S. Pat. No. 6,601,637 issued on Aug. 5, 2003, U.S. Pat. No. 8,469,078 issued on Jun. 25, 2013 the contents of which are incorporated by reference in their entirety.

The invention is an improved expandable and collapsible covering system for selectively covering structural openings such as doorways, windows, archways, or the like, where the covering includes a headrail and a vertically extending, collapsible panel suspended from the headrail having moveable vertical rails which can be locked in a fixed position so neither vertical rail is movable, so both vertical rails are moveable, and so that one vertical rail is fixed or the other is locked.

The instant invention utilizes a four-wheel trolley which rides in a first track and that secures to the upper end moveable rail and a fifth wheel that secures to the forward edge of the moveable rail and rides in a third track. This ensures that the moveable rail hangs straight and does not twist. The four-wheel trolley that secures to the upper end of the movable rail with has a vertical pivoting cylindrical base and swiveling base plate, and the trolley, along with the vertical pivoting cylindrical base, swiveling base plate, and moveable vertical rail facilitate the means by which the covering is expanded or collapsed along the axis of the headrail. The fifth wheel that secures to the forward edge of the moveable rail runs in the second track and eliminates the tendency for the four-wheel trolley to lift up and allows the instant invention to use a smaller trolley which reduces the stack height of the covering when it is collapsed along the axis of the headrail. In a third channel there is a second fabric covering which can be deployed to cover either all or partial segment of the structural opening. The two fabric covering and comprise of the following a first type consisting of a first fabric covering that is a shear fabric and the second fabric covering is a room darkening covering, a second type consisting a first fabric covering that is a room darkening covering and the second fabric covering is a shear covering, a third type consisting a first fabric covering that is a room darkening covering and the second fabric covering is a room darkening covering or any mixture of fabrics that meet the users needs.

The instant invention has a clearly defined headrail has at least three channels, the first channel that holds a first trolley and a second trolley and both trolleys can be moveable or fixed. However, the preferred embodiment is to have one moveable vertical rail and one fixed vertical rail. However, the instant invention envisions a structural opening cover that has two moveable vertical rails, one moveable vertical rail and one fix vertical rail and two fixed vertical rails. The moveable vertical rails are enabled by the first track to move along the length of the dual headrail and support at least one vertical rail which are configured to hold the leading and segment of the first fabric covering wherein said first fabric covering is preferably a pleated fabric covering. However, the instant invention envisions a multitude of fabric covering types that could be supported. The dual headrail second channel holds at least one second trolley which holds a trailing segment of the first fabric covering. The dual headrail has a second channel having a moveable carrier to support the first fabric covering and a third channel that supports at least one second fabric covering. The first fabric covering is suspended independently from the carriers. The carriers are attached to the fabric such that the carriers support the fabric as the moveable vertical rail is translated along the axis of the headrail in the first headrail track causing the pleats in the fabric panel to expand or contract, along the axis of the headrail which supports the pleated fabric covering using at least one carrier which moveable travel in a second track in the headrail. The position of the trolley and covering is maintained and defined by the headrail.

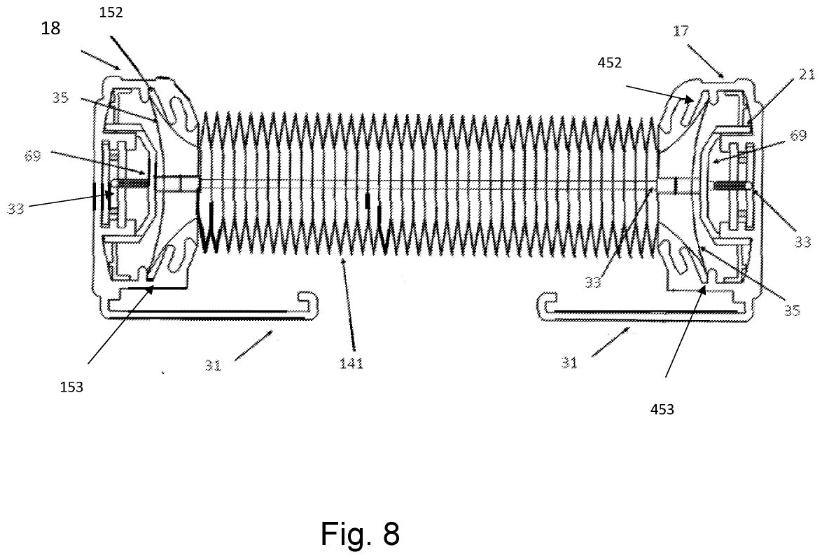

The entirety of the first fabric covering is stabilized by two parallel cords that run through the pleated fabric covering allowing the smooth, uniform, and desired appearance of the covering and its operation. Each cord allows travel through the movable rail and is attached at either end of the headrail, tension on the cord is maintained by a spring and an adjustable, lockable cord tensioner. The first fabric covering is preferably a pleated fabric covering that traverses the tension able cord by sliding along its fixed plane via the movable rail, along the length of the headrail. The movable rail has two cord guides 69 as shown in FIG. 8 that provide a smooth, uninterrupted passage through the interior of the rail and its axis. This stabilizing cord system exits through the top portion of the movable rail through the cord guide end cap, attached at both ends of the headrail, and any friction or binding is thus reduced, again, allowing for the smooth expansion and contraction of the pleated fabric covering.

The vertical rail is supported by a trolley which allows for uninterrupted motion along the headrail axis. As the vertical rail supported by the trolley is rolled along the length of the headrail and each stabilizing cord maintains a fixed spacing of the movable rail(s) and the pleated fabric covering in both the fully expanded and collapsed positions. The stabilizing cord prevents bunching and non-uniform gathering of the covering materials while providing the desired movement and appearance.

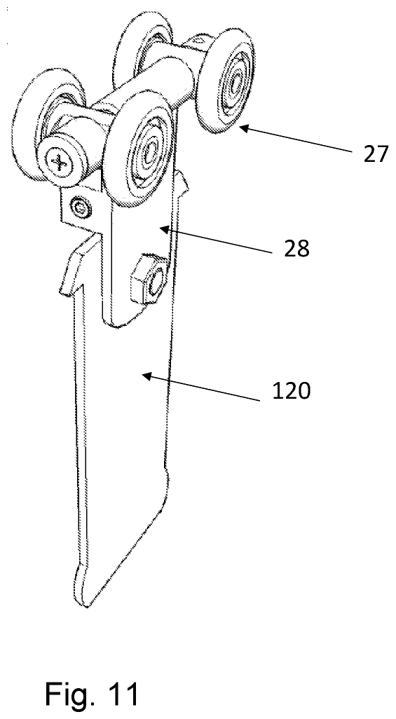

The trolley wheels nest inside the track and the pivoting base 28 shown in FIG. 11 prevents the wheels from jumping out of the headrail first track. The trolley wheels can engage both the upper and lower portions of the headrail first track thereby providing a clear, unrestricted transit for the trolley and attached vertical rail.

The expandable and collapsible pleated fabric covering is suspended along the length of the headrail and is movable by means of a plurality of carriers with attached roller bearings that ride in a second track within the headrail assembly that make the assembly slidable within the headrail. The roller bearings travel within a second track within the headrail with a rounded center to minimize friction and noise generated by the rollers during the manipulation of the movable rail. As the pleated fabric pleated fabric covering is retracted, the carriers travel along a common track with no encumbrances, subsequently the trolley travels along its exclusive first track and both the covering, trolley, and vertical rail travel the headrail in unison along the same axis. Because the trolley and the pleated fabric covering transit the headrail independently but in unison, this allows the aesthetically desired operation of the vertical retractable covering for structural openings.

The third channel is configured to hold a separate fabric covering so that the user can partially close the first fabric covering and the user can partially close the second fabric covering but leave a segment of the structural opening uncovered. The use of two vertical rails that are both moveable allow the segment uncovered to be the lower right-hand quadrant or the lower left-hand quadrant. The two vertical rails that are both moveable facilitate this by allowing the first fabric cover to be positioned along the dual headrail so that the first fabric cover can cover either the left or the right side of the structural opening. The second fabric covering being moveable can block the structural opening from the top to the bottom so the size of the segment of the structural opening uncovered is variable. This allows the user to limit the amount of direct sunlight that enters a space from a structural opening.

A second embodiment of the instant invention allows the third channel to be position in the dual headrail such that it is the most inside of the structural opening or proximal to the room or space enclosed by the structural opening. This allows the user to have a shear fabric covering on the inside of the room and a room darkening fabric covering on the side that faces the outside of the room. This allows the user to limit the amount of direct sunlight that enters a space from a structural opening.

An advantage of the instant invention is the ability to form the headrail from a number of separate pieces which facilitate fabrication the headrail on site so that it is configurable based on the customer needs. The headrail can be assembled such that the pleated fabric covering can face the inside or outside of the structural openings and the headrails can be spliced in the length direction so that any length headrail can be assembled to cover any size structural openings. This provides flexibility so that the user or blind technician can assemble from standard parts any configuration blind system desired by the client. The primary blind is the pleated fabric covering but the headrail system can have a lightweight secondary trolley for holding a sheer fabric trolly and fabric or it can hold a roll blind.

If the blind system is configured such that a pleated fabric covering faces the inside and the vertical rail for the pleated fabric is on the right and a roll shade faces outside the client then the client can adjust the vertical blind and the roll shade so that only the right lower part of the structural opening allows a user or client to look through that part of the structural opening.

If the blind system is configured such that a pleated fabric covering faces the inside and the moveable vertical rail for the pleated fabric covering is on the left and a roll shade faces outside the client then the client can adjust the vertical blind and the roll shade so that only the right lower part of the structural opening allows a user or client to look through that part of the structural opening.

If the blind system is configured such that a pleated fabric covering faces the outside and the moveable vertical rail for the pleated fabric covering is on the left, a sheer fabric is supported by the secondary rail and that rail is faces the inside faces the client can adjust the vertical blind and the sheer fabric so that only the left part of the structural opening allows a user or client to look the sheer fabric through that part of the structural opening not covered by the pleated fabric covering.

If the blind system is configured such that a pleated fabric covering faces the outside and the moveable vertical rail for the pleated fabric covering is on the right, a sheer fabric is supported by the secondary rail and that rail is faces the inside faces the client can adjust the vertical blind and the sheer fabric so that only the right part of the structural opening allows a user or client to look the sheer fabric through that part of the structural opening not covered by the pleated fabric covering.

If the blind system is configured such that a pleated fabric covering faces the inside and a roll shade faces outside the client then the client can adjust the vertical blind and the roll shade so that only the lower part of the structural opening allows a user or client to look through that part of the structural opening.

The instant invention in one embodiment is a dual headrail and the dual headrail having a first track, a second track and a third track. The instant invention right-side vertical rail is attached to a trolley and the is trolly horizontally moveable within the dual headrail the first track.

The instant invention left-side vertical rail is attached to a trolley and the trolly is horizontally moveable within the dual headrail the first track;

The instant invention pleated fabric covering is attached to at least one fabric carrier and the at least one fabric carrier having a wheel and the wheel horizontally moveable within the dual headrail the second track.

The instant invention right-side vertical rail has two pleated fabric receivers one for a larger width pleated fabric and one for a smaller width pleated fabric and the left-side vertical rail having two pleated fabric receivers a first receiver one for a larger width pleated fabric covering and a second receiver for a smaller width pleated fabric covering.

The first fabric covering consisting of a pleated fabric having a larger width pleated fabric fitting into in the first receiver the right-side vertical rail and the first receiver the left-side vertical rail and the third track receiving a second fabric covering independently operable from the first fabric covering.

The retractable covering of the instant invention wherein the second fabric covering is selected from the group consisting of sheer fabric, roll shade fabric, pleated fabric, vertical blind fabric and a curtain.

The retractable covering of the instant invention wherein the first track is proximal to the inside of the structural opening such that the third track is distal from the inside of the structural opening.

The retractable covering of the instant invention wherein the first track is distal to the inside of the structural opening such that the third track is proximal from the inside of the structural opening.

The retractable covering of the instant invention wherein the right-side vertical rail having two pleated fabric receivers comprising a first receiver for a larger width pleated fabric and a second receiver for a smaller width pleated fabric and a user inserts the pleated fabric into the receiver depending on the size of the pleated fabric. Therefore, the person assembling the retractable covering determines the size of the pleated fabric and selects the appropriate receiver pair to use.

The retractable covering of the instant invention wherein said valance is made using a continuous roll forming process at the site of the structural opening.

The retractable covering of the instant invention wherein said dual rail is made from at least two dual rails joined together. The at least two dual rails can be joined together using a splice plate or spicing sleeve that can be attached to the at least two dual rails by screws, adhesive, clamps or pins.

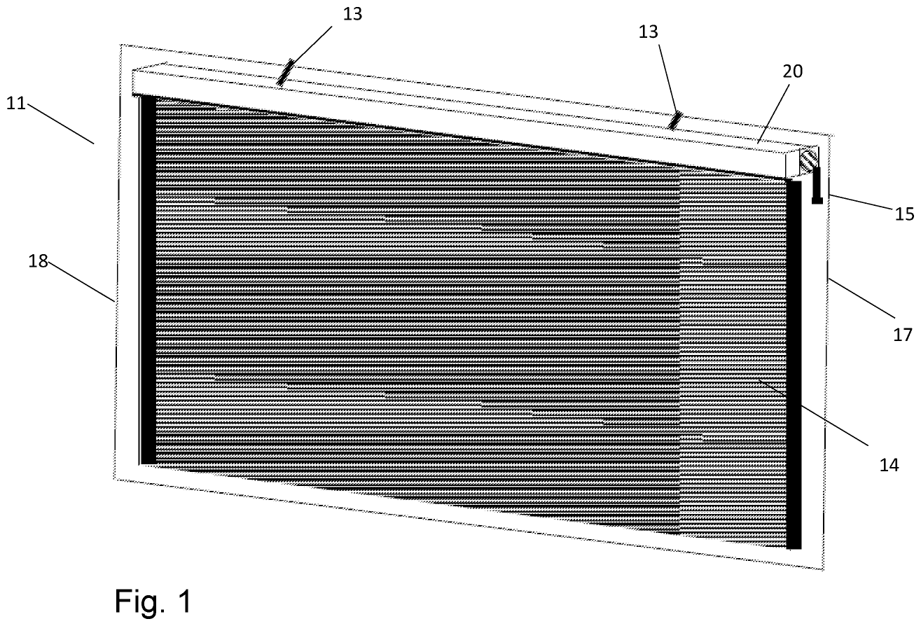

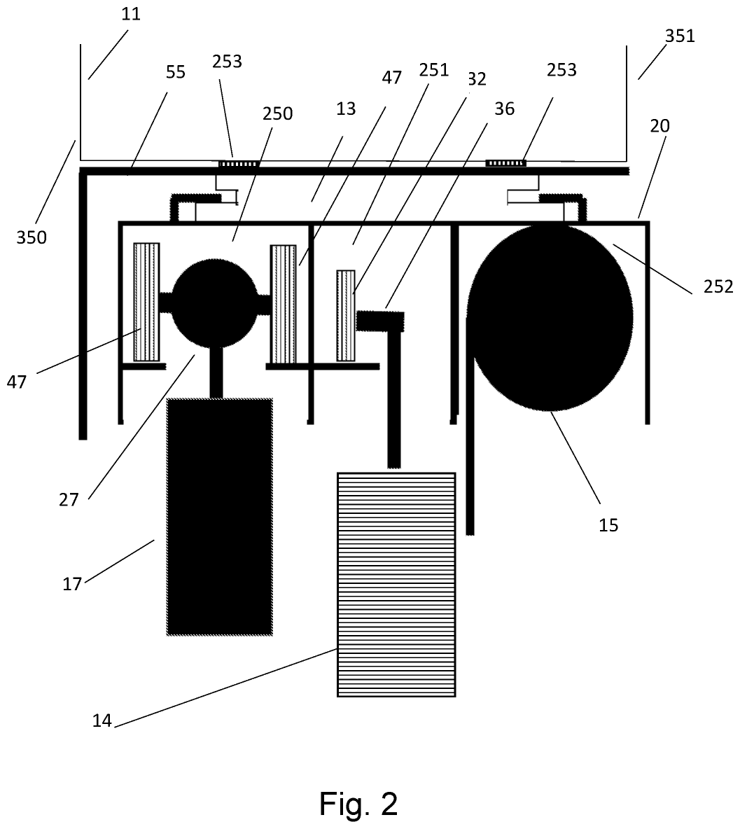

Referring now to the drawings, and more particularly to FIGS. 1-12 and particularly FIG. 1 there is shown vertical retractable covering for structural openings 11 having a at least two vertical rails. The right vertical rail 17 and left vertical rail 18 are configured to accept at least two different sizes of collapsible pleated fabric covering 14. The dual headrail 20 is also configured to accommodate at least two separate fabric coverings which include a pleated fabric covering 14 and a second fabric covering 15 selected from the group comprising of sheer fabric, roll shade fabric, pleated fabric, vertical blind fabric and a curtain. The movable pleated fabric covering is expandable and collapsible between various positions and the dual headrail 20 includes a structural member that supports two separate fabric coverings for the structural opening in two separate channels or tracks. The two separate fabric coverings allow the user of the system to alternatively deploy either one or both of the pleated fabric covering 14 and a second fabric covering 15. This allows the user to open and close the combination pleated fabric covering 14 and a second fabric covering 15 so that only certain segments of the structural opening are not covered by either pleated fabric covering 14 and a second fabric covering 15 or both. The dual headrail 20 is attached to the structural opening with an installation bracket 13, which in turn supports a vertically-extending, horizontally expandable and collapsible pleated fabric covering 14 which is horizontally movable and second fabric covering 15 which is either horizontally movable or vertically moveable. The collapsible pleated fabric covering 14 and second fabric covering 15 independently are independently movable from each other. The dual headrail 20 can utilize 1 or more installation brackets 13 to connect the dual headrail 20 to the structural openings 11 with fasteners 253. The structural opening 11 has an inside 350 shown in FIG. 2 and an outside 351 shown in FIG. 2.

The dual headrail 20 is configurable such that the pleated fabric covering 14 can face either the inside 350 or the outside 351 of the structural openings 11.

Referring to FIG. 2 is an end view of the dual headrail 20 configured such that the pleated fabric covering 14 faces the inside 350 of the structural opening 11 (shown in FIG. 1) and second fabric covering 15 faces the outside 351 of the structural opening 11 (shown in FIG. 1). The instant invention solves the problem of long structural openings 11 by providing for a continuous valence 55 made on site that covers the connections between dual rails so that as many rails as necessary can be joined together to cover a structural opening 11. The vertical rail 17 and left vertical rail 18 (shown in FIG. 1) are supported by the trolley 27 having trolley roller bearing wheels 47 which are installed in first track 250 and carrier roller bearing wheels 47 and the pleated fabric covering is supported by at least one rail carriers 36 and roller bearings 32 in second track 251 and second fabric covering 15 is installed in the third track 252. The pleated fabric covering 12 is supported by at least one carrier 36 and roller bearings 37.

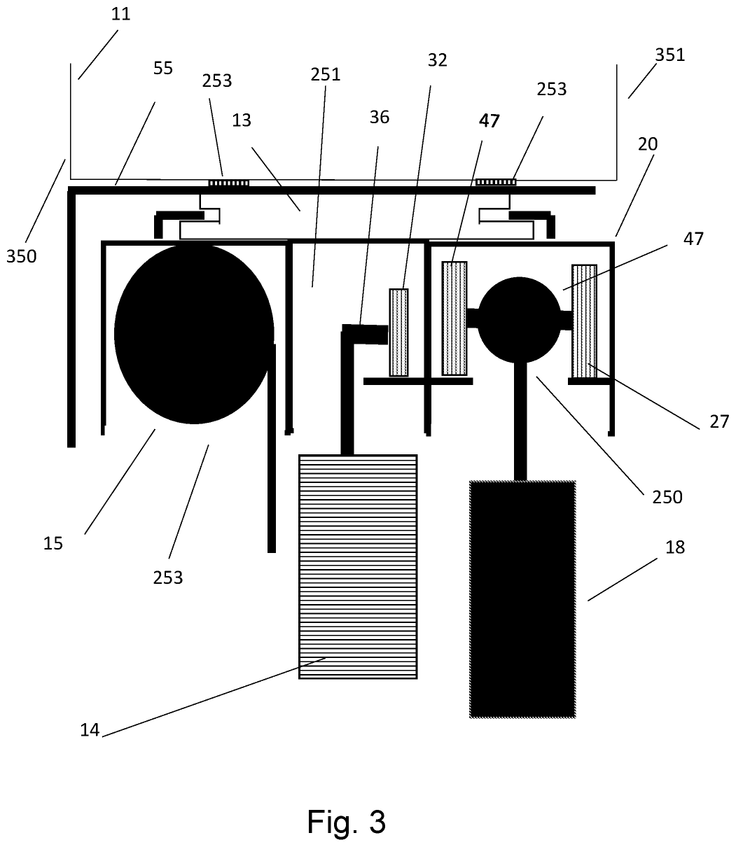

FIG. 3 is an end view of the dual headrail 20 configured such that the pleated fabric covering 14 faces the outside 351 of the structural opening 11 (shown in FIG. 1). The instant invention solves the problem of long structural openings 11 by providing for a continuous valence 55 made on site that covers the connections between dual rails so that as many rails as necessary can be joined together to cover a structural opening 11. The vertical rail 17 and left vertical rail 18 (shown in FIG. 1) are supported by the trolley 27 having trolley roller bearing wheels 47 which are installed in first track 250 and carrier roller bearing wheels 47 and the pleated fabric covering is supported by at least one rail carriers 36 and roller bearings 32 in second track 251 and second fabric covering 15 is installed in the third track 253. The pleated fabric covering 12 is supported by at least one carrier 36 and roller bearings 37. The vertical rail 17 and left vertical rail 18 (shown in FIG. 1) are supported by the trolley 27 having trolley roller bearing wheels 47 which are installed in first track 250 and second fabric covering 15 is supported in the third track 253.

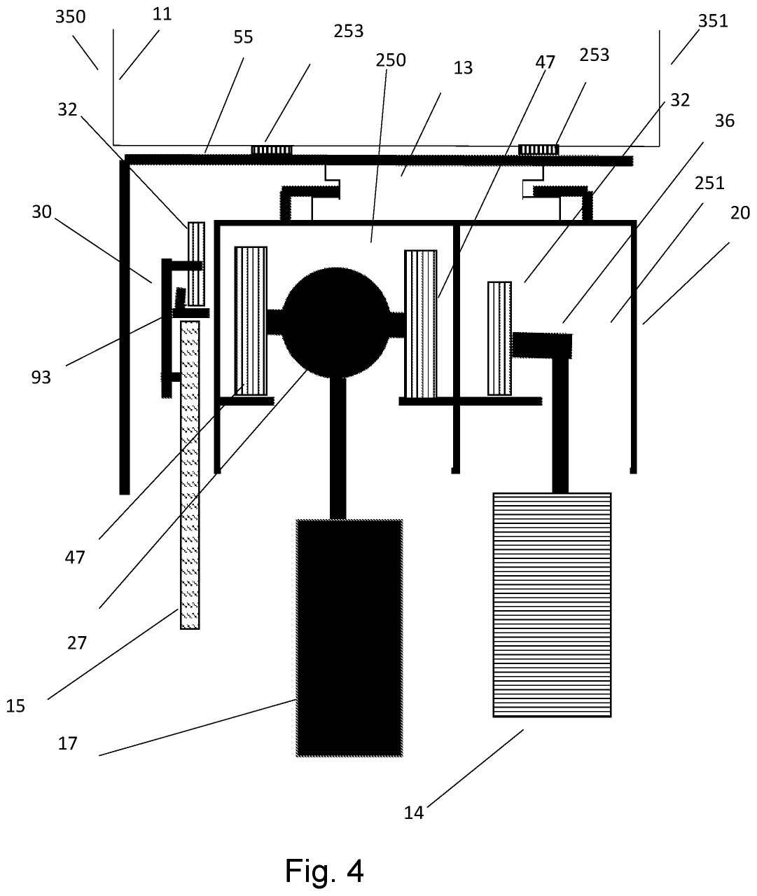

Referring to FIG. 4 which shows a cross section view of a dual headrail 20 showing a vertical blind in the outside 351 of the structural opening 11 and a second fabric covering 15 facing the inside 350 of the structural openings 11. The second fabric covering 15 is supported by at least one curtain carriers 30 which the invention refers to as the third track 93 for this embodiment which has a roller bearing wheels 32 that rides in track 93. The vertical rail 17 and left vertical rail 18 (shown in FIG. 1) are supported by the trolley 27 having trolley roller bearing wheels 47 which are installed in first track 250 and carrier roller bearing wheels 47 and the pleated fabric covering is supported by at least one rail carriers 36 and roller bearings 32 in second track 251 and second fabric covering 15 is installed in the third track 93. The pleated fabric covering 12 is supported by at least one carrier 36 and roller bearings 37. The vertical rail 17 and left vertical rail 18 (shown in FIG. 1) are supported by the trolley 27 having trolley roller bearing wheels 47 which are installed in first track 250 and second fabric covering 15 is supported in the third track 93 from one curtain carriers 30 and a roller bearing wheels 32.

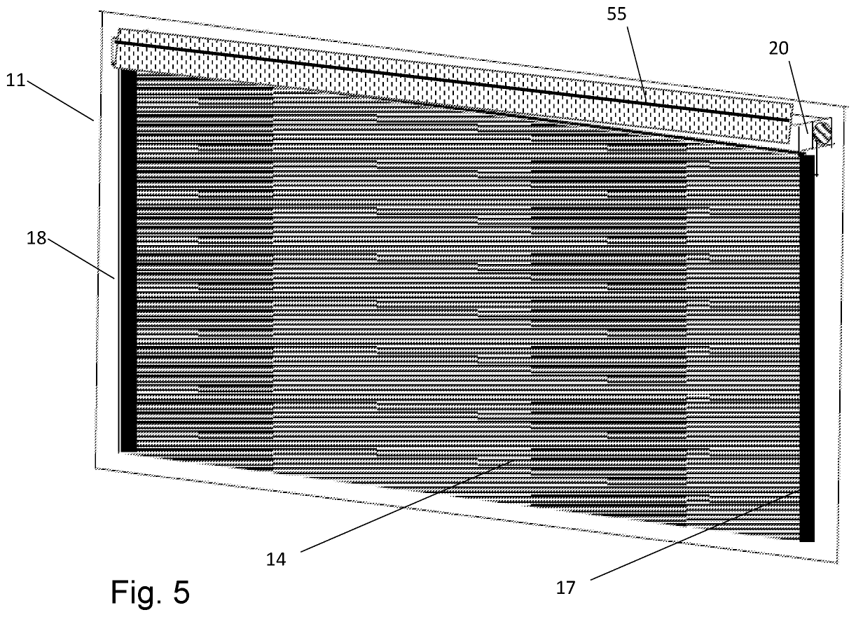

Referring to FIG. 5 is an isometric view of a side-draw embodiment of the instant invention with continuous valence 55. The headrail 20 is supported from the structural opening 11 and the pleated fabric covering 14 is suspended from the headrail 20. The headrail 20 also supports vertical rail 17 and vertical rail 18.

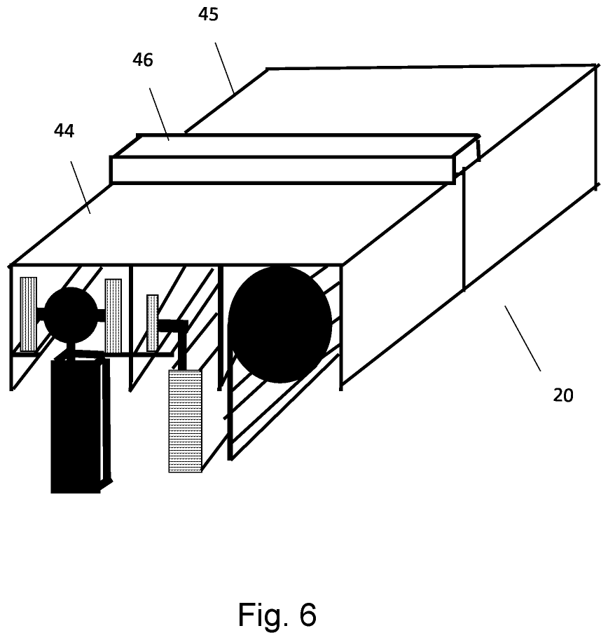

Referring to FIG. 6 shows a first dual headrail 44 and a second dual headrail 45 joined together with splicing block 46 to form a single dual headrail 20.

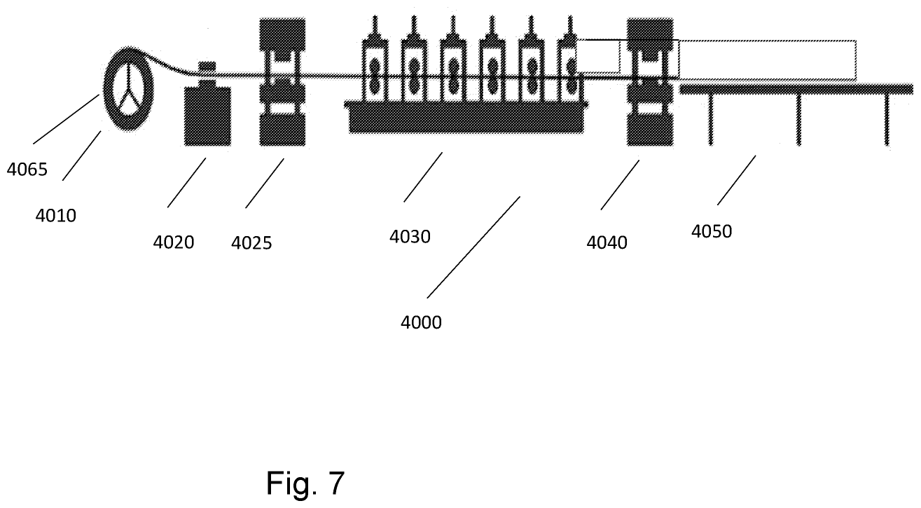

Referring to FIG. 7 shows the continuous valence process. The current vertical blind systems all have issues with the need to join two headrail segments together to form a long dual headrail required by long structural openings. This type of joining forms an unsightly seam which the current practice is the provide a decorative joining device to join the two headrails. The instant invention provides a method to fabricate a valence on sight to the dimensions need to cover the multiple headrail segments so that it appears to be a single dual headrail. To accomplish this the instant invention uses a roll of color matched sheet metal and forms it into a continuous valance on sight so that it is made to fit the installation using a continuous roll forming machine 4000. A roll of sheet material 4065 is placed on the uncoiler step 4010. Sheetmetal coils may become set during storage and tend to stay coiled and become distorted. To correct the problem, the coil is loaded onto the uncoiler, and fed through a flattener Step 4020 to remove the coil set. The lead end is trimmed to allow for smooth feeding into the pre-press process.

Step 4025 is the pre-press treatment which adds the holes for the joining the dual headrail 20 and before the metal from the coil is fed into the roll forming rollers.

Step 4030 is the roll forming step where the material is progressively shaped. A typical roll forming machine can consist of 10 to 24 pairs of roller die stands. The machine forces the ribbon of sheet metal through the rollers that gradually shape into the valence.

Step 4040 is the Cutoff and discharge step where the parts are cut to length as they are in motion, which increases the efficiency and speed of the roll forming process. Once they are cut, they are discharged to a run-out table Step 4050 to be placed for installation

The continuous roll forming process allows the blind fabrication to create a blind system that is as look as need and that visually does not have any valence joints which improves the aesthetic visibility of the blind installation. The continuous roll forming of the instant invention is portable and can be a tabletop or be moved to the site of installation using a wheeled dolly.

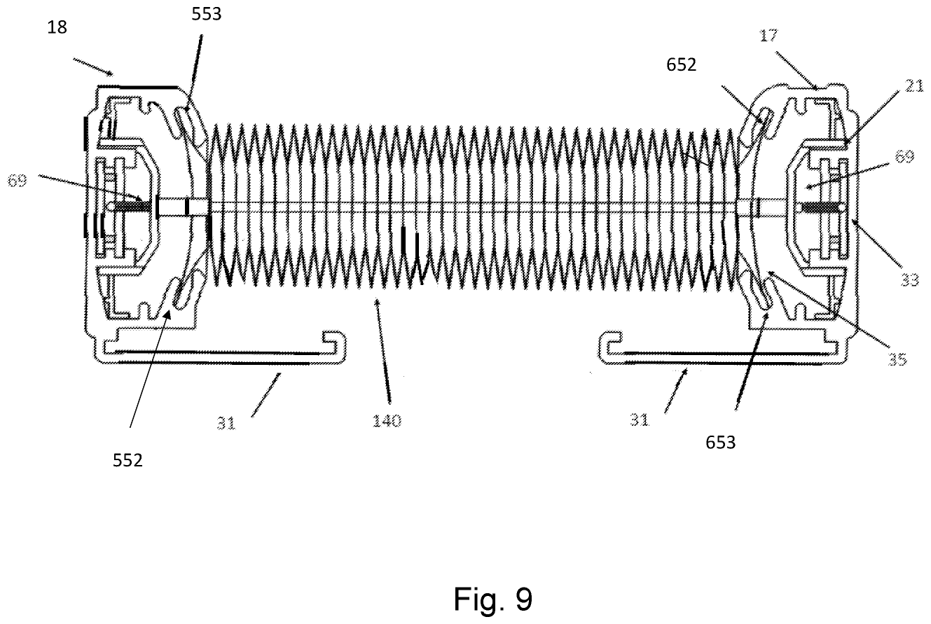

As shown in FIG. 8 which shows an enlarged section plan view taken with respect to the larger pleated fabric covering and both vertical rails without the dual headrail 20 or the second fabric covering and FIG. 9 which shows an enlarged section plan view taken with respect to the smaller pleat fabric covering and both vertical rails without the dual headrail 20 or the second fabric covering.

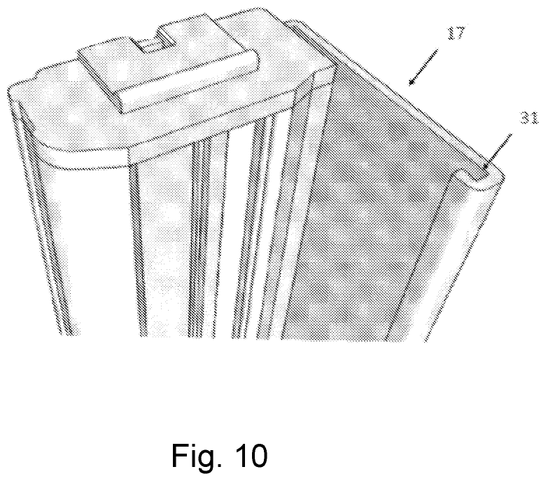

Both the vertical rail 17 and left vertical rail 18 are attached the trolley 27 by channel 31 which are best illustrated in FIGS. 8, and 9, having identical cross sections but are shown with a mirrored orientation to one another. The vertical rail 17 can be seen in greater detail in FIG. 10 with channel 31.

Also shown in FIG. 8 vertical rail 17 has two receivers that are designed to accommodate common size pleated fabric covering. Looking at the receivers for a typical 9/16-inch pleated fabric covering 141 which is formed by vertical rail 17 channel right side 152 and channel left side 153 and is held in place using the channel filler 35. The vertical rail 18 has two receivers that are designed to accommodate common size pleated fabric covering and the instant invention envisions that the size of the pleated fabric can vary depending on the need of the customer. Looking at the receivers for 9/16-inch pleated fabric covering 141 which is formed by vertical rail 18 channel right side 452 and channel left side 453 and is held in place using the channel filler 35.

The pleated fabric covering 141 is preferably a pleated fabric covering that traverses the tension able cord by sliding along its fixed plane via the movable rail, along the length of the headrail. The movable rail has two cord guides 69 that provide a smooth, uninterrupted passage through the interior of the rail and its axis. This stabilizing cord system exits through the top portion of the movable rail through the cord guide end cap, attached at both ends of the headrail, and any friction or binding is thus reduced, again, allowing for the smooth expansion and contraction of the pleated fabric covering. In addition, there are there are non-extensible cords 33.

Also shown in FIG. 9 vertical rail 17 has two receivers that are designed to accommodate common size pleated fabric covering. Looking at the receivers for ¾″ pleated fabric covering 140 which is formed by vertical rail 18 channel right side 552 and channel left side 553 and is held in place using the channel filler 35. The vertical rail 18 has two receivers that are designed to accommodate common size pleated fabric covering. Looking at the receivers for ¾″ pleated fabric covering 141 which is formed by vertical rail 17 channel right side 652 and channel left side 653 and is held in place using the channel filler 35.

FIG. 9 also shows the J-hook 21 which is used to lock the vertical rail 17 to the structural opening 11, are depicted and allow the movable rail made from vertical rail 17 to remain in a fixed position, accommodating a dual, single, and center drawn retractable covering position. All vertical rails, regardless of their position are affixed to the trolley 27 (shown in FIG. 2), which is reversable so the same trolley 27 can be used for either vertical rail 18 or vertical rail 18. The pleated fabric 140 and 141 has a vertical edge 15 which is horizontally movable, independently movable from each other. In addition, there are there are non-extensible cords 33.

In FIG. 10 is shown a vertical rail 17 which is similar to vertical rail 18 showing by channel 31 which the trolley 27 attaches to.

In FIG. 11 there is shown a trolley 27 with vertical rail connecting plate 120 which connects to channel 31 shown in FIG. 10.

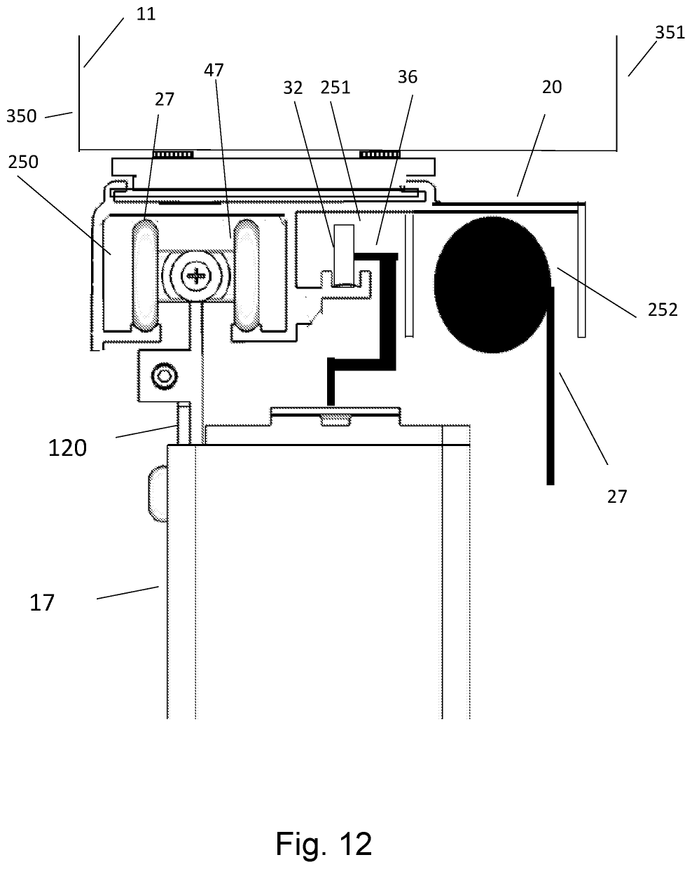

In FIG. 12 there is shown an end view of the dual headrail 20 configured such that the pleated fabric covering 14 (shown in in FIG. 2) faces the inside 350 of structural opening 11 and the roll shade 27 faces the outside 351 of structural opening 11. The vertical rail 17 and left vertical rail 18 (shown in FIG. 1) are supported by the trolley 27 installed in first track 250 having a vertical rail connecting plate 120 and trolley roller bearing wheels 47 and the pleated fabric covering (shown in FIG. 2) is supported by at least one rail carriers 36 and roller bearings 32 in second track 251. Roll shade 27 is installed in the third track 252.

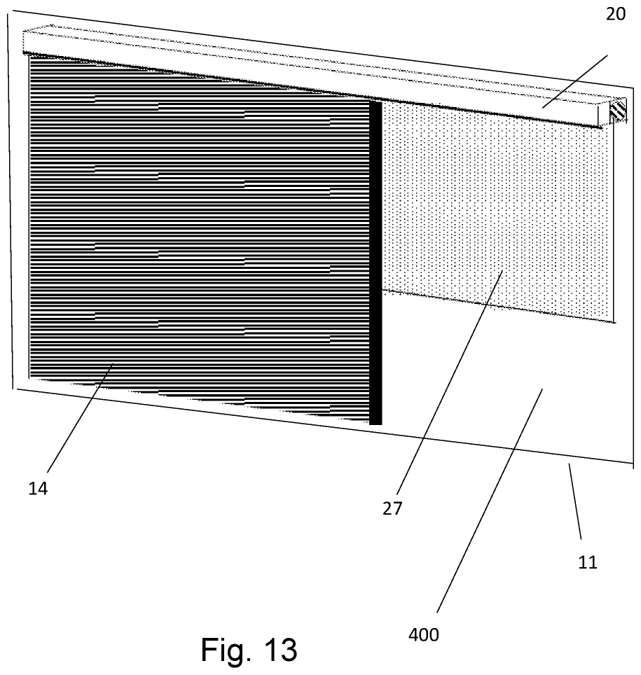

FIG. 13 shows a dual headrail 20 with pleated fabric 14 covering a portion of the structural opening 11 and roll shade 27 covering a portion of structural opening 11 leaving uncovered portion 400 of structural opening 11. This allows the user to allow light in but eliminate glare from the sun by closing roll shade 27 and pleated fabric 14 covering to only allow uncovered portion 400 to be expose to the sun.

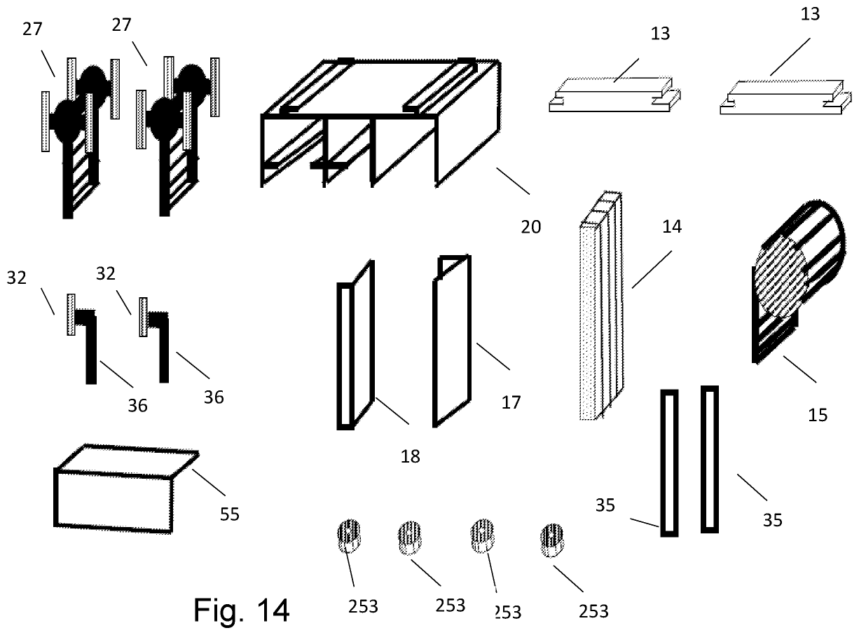

As shown in FIG. 14 the user can form a fabric covering using a vertical fabric covering from a kit comprising of the following parts:

a. a continuous roll forming machine 4000;

b. at least one dual headrail 20;

c. one vertical rail 17;

d. one vertical rail 18;

e. one valance sheet metal piece 4065;

f. two vertical rail trolleys 27;

g. two installation brackets 13;

h. four fasteners 253;

i. two rail carriers 36 and two roller bearings 32;

j. one pleated fabric 14;

k. two channel filler 35; and

l. one second fabric covering 15.

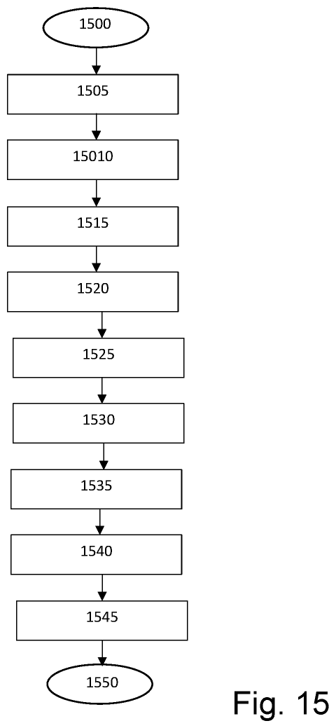

As shown in FIG. 15 which is a process flowchart a user can install a fabric covering system of the instant invention using a kit of the instant invention by using the following process 1500:

a. step 1505 forming a valance 55 using a continuous roll forming machine 4000 and valance sheet metal piece 4065;

b. step 1510 attaching said valance 55 to a dual headrail 20 using two installation brackets 13 and four fasteners 253 and said dual headrail 20 having a first track 250, a second track 251 and a third track 252;

c. step 1515 installing a vertical rail trolley 27 in said first track 251 to support a left vertical rail 18 in said dual headrail first track 250;

d. step 1520 installing a vertical rail trolley 27 in said first track 251 to support a right vertical rail 17 in said dual headrail first track 250;

e. step 1525 installing at least one rail carrier 36 and roller bearings 32 in said second track 251;

f. step 1530 attaching a pleated fabric panel to at least one rail carrier 36 and attaching said pleated fabric panel to said left vertical rail 18 using a channel filler 35 and attaching said pleated fabric panel to said right vertical rail 17 using a channel filler 35.

g. step 1535 installing a second fabric covering 15 in said third track 252;

h. step 1540 thereby forming a fabric covering system;

i. step 1545 attaching said fabric covering system to a structural opening 11; and

j. Step 1550 stop.

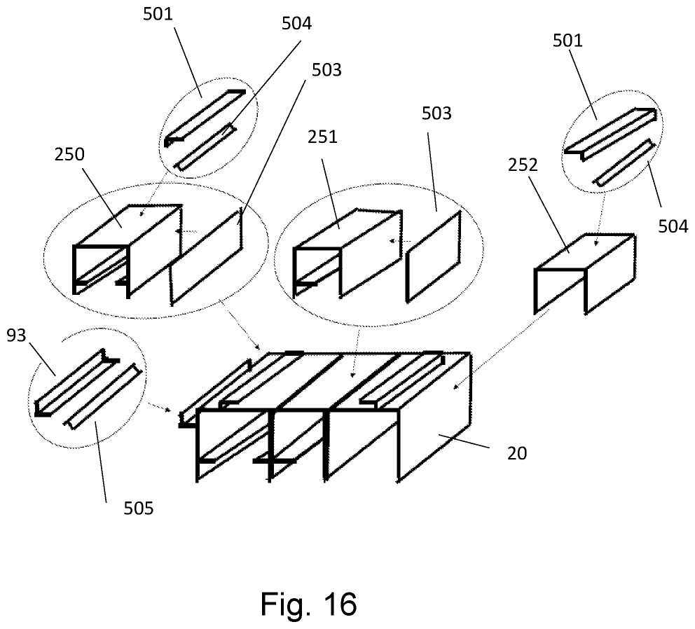

As shown in FIG. 16 the dual rail can alternatively be assembled from up to 3 different tracks to form the dual headrail 20. The first track 250, second track 251 and third track 252 can be formed from separate pieces and assembled into dual headrail 20. Hangers 501 can be attached separately to form a hanger attachment so that the assembled dual headrail 20 can attach to installation brackets 13 shown in FIG. 2. The hangers 501 can be attached the first track 250, second track 251 and third track 252 using adhesive, screws, clips or pins. The tracks can be attached by a mechanical method to each other and the mechanical method can be any suitable method including adhesive, screws, clips or pins. FIG. 16 shows that the first track 250, second track 251 and third track 252 attached together using adhesive strips 503 and hangers 501 are attached to the first track 250 and third track 252 using adhesive strips 504.

The track 93 can be attached to the assembled dual headrail 20 by adhesive strips 505.

This makes the headrail configurable thereby saving the user or installer from having to stock multiple dual headrail configurations. By stocking track 93, adhesive strips 505, first track 250, second track 251 and third track 252, adhesive strips 503, hangers 501 and adhesive strips 504 the installer or user can configure any format of dual headrail 20 that they need to for a specific installation. For example, they could form a dual headrail 20 with a track 93, first track 250, second track 251 and third track 252, They could alternatively form a dual headrail 20 with a track 93, first track 250 and second track 251.

They could alternatively form a dual headrail 20 with a first track 250, second track 251 and third track 252 or third track 252, first track 250 and a second track 251.

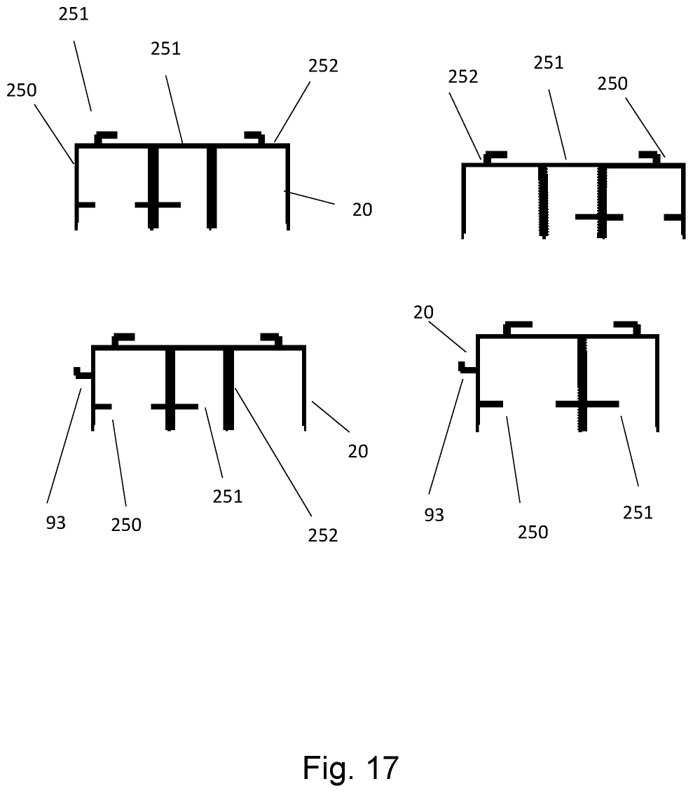

The ability to individually configure the dual headrail and make a continuous valance gives the user numerous possible configurations to meet the different requirements to cover a structural opening. FIG. 17 shows the following configurations of dual headrail 20 from an end view of the headrail 20. Element 1710 shows a headrail 20 from left to right with first track 250, second track 251 and third track 252. Element 1715 shows a headrail 20 from left to right with track 93, first track 250, second track 251 and third track 252. Element 1720 shows a headrail 20 from left to right with third track 252, second track 251 and first track 250, Element 1725 shows a headrail 20 from left to right with first track 250 and second track 25.

Other combinations are envisioned by the instant invention.

The Vertical Retractable Covering for Structural Openings has been described herein with fixed and movable rails along opposite side edges of an expanding and collapsing pleated fabric covering and is retained in a parallel relationship, while a trolley connecting the movable vertical rail to the headrail is retained in a desired relationship to assure smooth gliding movement of the movable rail along the length of the headrail between extended and retracted positions of the covering. It should also be appreciated that the use of a single roller bearing wheel at the distal end of the of the trolley engageable in a single channel separate from a channel utilized by the rail carriers for supporting the pleated fabric covering enables the rail carriers to stack along the horizontal length of the trolley to permit uniform gathering of the pleated fabric covering along its full width including the portion of the covering that overlies the length of the trolley.

Although the Vertical Retractable Covering for Structural Openings has been described with a certain degree of particularity, let it be understood that the disclosure has been made by way of example, and changes in detail or structure may be made without departing from the spirit of the invention as defined in the appended claims.

While this invention has been described with respect to at least one embodiment, the instant invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

Since many modifications, variations, and changes in detail can be made to the described embodiments of the invention, it is intended that all matters in the foregoing description and shown in the accompanying drawings be interpreted as illustrative and not in a limiting sense. Furthermore, it is understood that any of the features presented in the embodiments may be integrated into any of the other embodiments unless explicitly stated otherwise. The scope of the invention should be determined by the appended claims and their legal equivalents.

In addition, the present invention has been described with reference to embodiments, it should be noted and understood that various modifications and variations can be crafted by those skilled in the art without departing from the scope and spirit of the invention. Accordingly, the foregoing disclosure should be interpreted as illustrative only and is not to be interpreted in a limiting sense. Further it is intended that any other embodiments of the present invention that result from any changes in application or method of use or operation, method of manufacture, shape, size, or materials which are not specified within the detailed written description or illustrations contained herein are considered within the scope of the present invention.

As far as the description above and the accompanying drawings disclose any additional subject matter that is not within the scope of the claims below, the inventions are not dedicated to the public and the right to file one or more applications to claim such additional inventions is reserved.

Although very narrow claims are presented herein, it should be recognized that the scope of this invention is much broader than presented by the claim. It is intended that broader claims will be submitted in an application that claims the benefit of priority from this application.

While this invention has been described with respect to at least one embodiment, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

What is claimed is:

1. A retractable covering for structural openings comprising:
a. a dual headrail and said dual rail having a first track, a second track and a third track;
b. said dual headrail having a valence;
c. a right-side vertical rail attached to a trolley and said trolley horizontally moveable within said dual headrail said first track;
d. a left-side vertical rail attached to a trolley and said trolley horizontally moveable within said dual headrail said first track;
e. a pleated fabric covering attached to at least one fabric carrier and said at least one fabric carrier having a wheel and said wheel horizontally moveable within said dual headrail said second track;
f. said right-side vertical rail having two pleated fabric receivers one wherein the first receiver for a larger width pleated fabric and second receiver for a smaller width pleated fabric;
g. said left-side vertical rail having two pleated fabric receivers one wherein the first receiver for a larger width pleated fabric and second receiver for a smaller width pleated fabric;
h. a first fabric covering consisting of a pleated fabric having a larger width pleated fabric fitting into in said first receiver said right-side vertical rail and said first receiver said left-side vertical rail; and
i. said third track receiving a second fabric covering independently operable from said first fabric covering.

2. The retractable covering of claim 1 wherein said second fabric covering is selected from the group consisting of sheer fabric, roll shade fabric, pleated fabric, vertical blind fabric and a curtain.

3. The retractable covering of claim 1 wherein said retractable covering is installed in said structural opening such that is first track is proximal to said inside of said structural opening such that said third track is distal from said inside of said structural opening.

4. The retractable covering of claim 1 wherein said first track is distal to said inside of said structural opening such that said third track is proximal from said inside of said structural opening.

5. The retractable covering of claim 1 wherein said right-side vertical rail having two pleated fabric receivers comprising a first receiver for a larger width pleated fabric and a second receiver for a smaller width pleated fabric and a user insert said pleated fabric into said receiver depending on the size of said pleated fabric.

6. The retractable covering of claim 1 wherein said valance is made using a continuous roll forming process at the site of the structural opening.

7. The retractable covering of claim 1 wherein said dual rail is made from at least two dual rails joined together.

8. A kit for a fabric covering using a vertical fabric covering comprising:
a. a continuous roll forming machine;
b. at least one dual headrail;
c. one left vertical rail;
d. one right vertical rail;
e. one valance sheet metal piece;
f. two vertical rail trolleys;
g. two installation brackets;
h. four fasteners;
i. two rail carriers 36 and two roller bearings;
j. one pleated fabric;
k. two channel filler; and
l. one second fabric covering.

9. A method to install a fabric covering system of the instant invention using a kit of claim 8 the steps comprising of:
a. First forming a valance using a continuous roll forming machine and valance sheet metal piece;
b. attaching said valance to a dual headrail using two installation brackets and four fasteners and said dual headrail having a first track, a second track and a third track.;
c. installing a vertical rail trolley in said first track to support a left vertical rail in said dual headrail first track;
d. installing a vertical rail trolley in said first track to support a right vertical rail in said dual headrail first track;
e. installing at least one rail carrier 36 and roller bearings in said second track;
f. attaching a pleated fabric panel to at least one rail carrier and attaching said pleated fabric panel to said left vertical rail using a channel filler and attaching said pleated fabric panel to said right vertical rail using a channel filler.
g. installing a second fabric covering in said third track;
h. thereby forming a fabric covering system
i. attaching said fabric covering system to a structural opening.

10. The retractable covering of claim 1 wherein said dual rail is assembled from left to right with separate tracks and said first track is attached using a mechanical method to said second track with a which is attached using a mechanical method to said third track.

11. The retractable covering of claim 10 wherein said mechanical method is selected from the group consisting of adhesive, screws, clips and pins

12. The retractable covering of claim 10 wherein said dual rail said first track is attached to said second track with adhesive.

13. The retractable covering of claim 10 wherein said dual rail said second track is attached to said third track with adhesive.
